(19) United States
(12) Patent Application Publication
(10) Pub. No.: US 2026/0332463 A1
(43) Pub. Date: Oct. 22, 2026

(54) PHYSICAL LAYER METHODS TO ENABLE TONE-DISTRIBUTED RESOURCE UNITS

(71) Applicant: InterDigital Patent Holdings, Inc., Wilmington, DE (US)

(72) Inventors: Mahmoud Saad, L’Ile Bizard, Montreal (CA); Zinan Lin, Basking Ridge, NJ (US); Hanqing Lou, Syosset, NY (US); Rui Yang, Melville, NY (US); Safi Shams Muhtasimul Hoque, New York, NY (US)

(21) Appl. No.: 19/481,144

(22) PCT Filed: May 1, 2024
(86) PCT No.: PCT/US2024/027198

§ 371 Date: Nov. 3, 2025

Related U.S. Application Data
(60) Provisional application No. 63/464,071, filed on May 4, 2023.
(60) Provisional application No. 63/537,156, filed on Sep. 7, 2023.
(60) Provisional application No. 63/537,673, filed on Sep. 11, 2023.
(60) Provisional application No. 63/546,304, filed on Oct. 30, 2023.
(60) Provisional application No. 63/608,655, filed on Dec. 11, 2023.

(51) Int. Cl. H04L 27/26; H04L 5/00

(52) U.S. Cl. CPC H04L 27/261; H04L 5/0044; H04L 5/0094

(57) ABSTRACT

A method for communication performed by a wireless transmit/receive unit (WTRU) in a wireless local area network includes transmitting a message in a group of data tones in a combined tone-distributed resource unit (TD-RU), wherein a signal field of a preamble of a protocol data unit (PDU) indicates the data tones used for the transmission of the message, and wherein the combined TD-RU is composed of a tone plan that includes an arrangement of data tones such that a first and second small TD-RUs are included in the combined TD-RU, where the combined TD-RU has a bandwidth that encompasses a combined bandwidth of the first small TD-RU and a bandwidth of the second small TD-RU, wherein the arranged data tones in the combined TD-RU are organized in multiple groups of one or more tones, and receiving a message via the data tones of the combined TD-RU.

### CROSS REFERENCE TO RELATED APPLICATIONS

This application claims the benefit of U.S. provisional patent application No. 63/464,071 filed 4 May 2023, U.S. provisional patent application No. 63/537,156 filed 7 Sep. 2023, U.S. provisional patent application No. 63/537,673 filed 11 Sep. 2023, U.S. provisional patent application No. 63/546,304 filed 30 Oct. 2023, and U.S. provisional patent application No. 63/608,655 filed 11 Dec. 2023, each of which are incorporated by reference herein in their entirety.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of EHT-SIG content channel format for OFDMA transmission if bandwidth is 20/40/80 MHz;

FIG. 3 illustrates an example of EHT-SIG content channel format for OFDMA transmission if bandwidth is 160 MHz;

FIG. 4 illustrates an example of EHT-SIG content channel format for OFDMA transmission if bandwidth is 320 MHz;

FIG. 5 illustrates an example of EHT-SIG content channel format for non-OFDMA transmission to multiple users;

FIG. 6 illustrates an example of TD-RU;

FIG. 7 illustrates an example of tone distribution of a 26-tone TD-RU in 20 MHz;

FIG. 8 illustrates an example of tone distribution of a 26-tone TD-RU in 20 MHz with guard subcarriers;

FIGS. 9A and 9B depict an example tone plan for the TD-RU to lower IQ imbalance;

FIG. 10 illustrates an example design of combining smaller TD-Rus to form a larger TD-RU;

FIG. 11 illustrates an example of locations of pilot tones in a 26-tone TD-RU;

FIG. 12 illustrates an example allocation of pilot tones closer to the data tones group;

FIG. 13 illustrates an example grouping of data tones around the pilot tones; and

FIG. 14 depicts an example method based on the disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

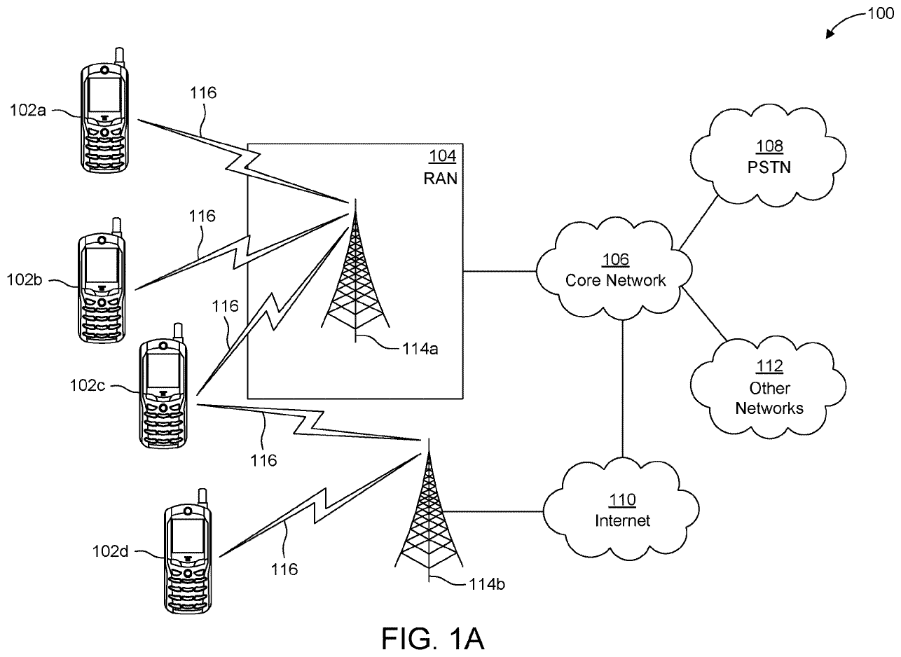

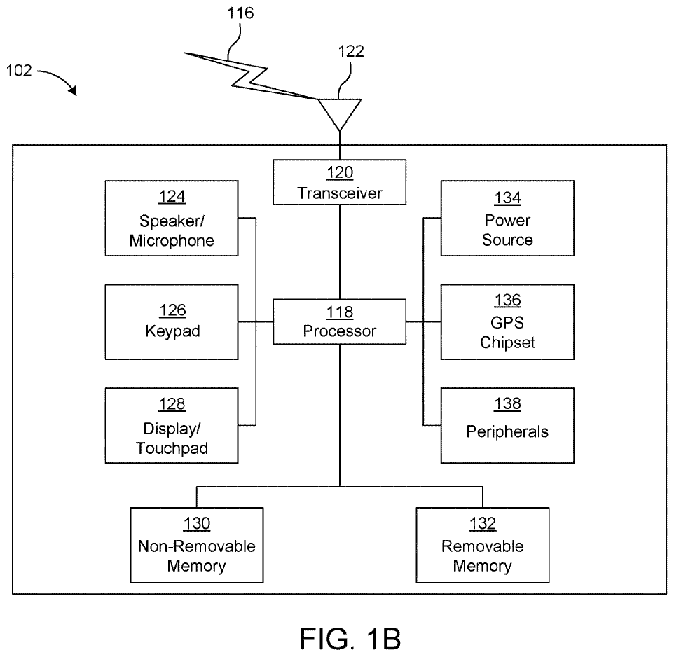

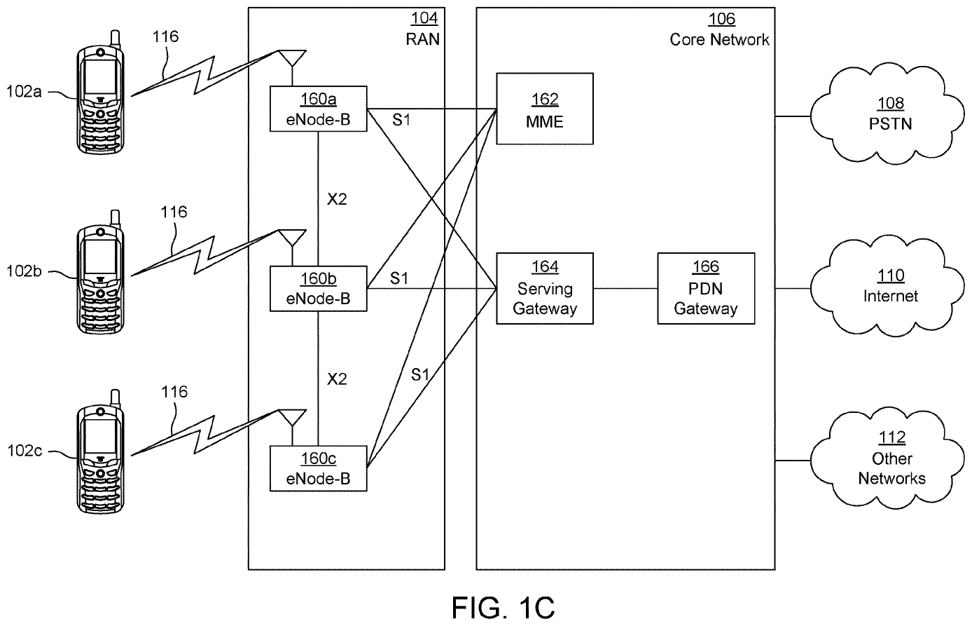

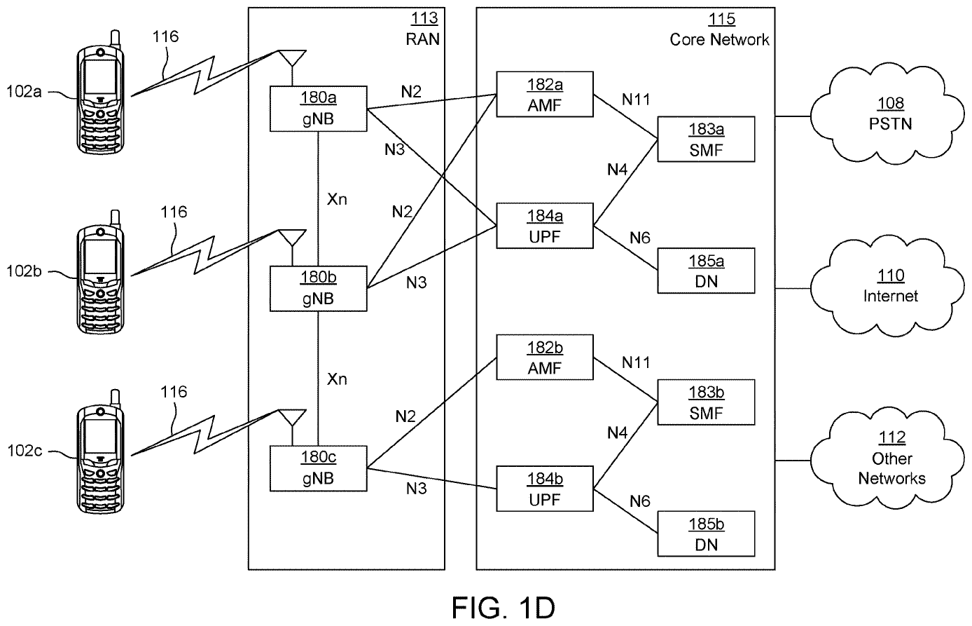

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite.

The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities.

Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.1 lac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connectto gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating user equipment (UE) IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit applicability of the subject matter to other wireless technologies, e.g., using the same or different principles as may be applicable.

As explained herein, a wireless transmit/receive unit (WTRU) may be an example of a user equipment (UE). Hence the terms UE and WTRU may be used with equal scope herein.

A WLAN in Infrastructure Basic Service Set (BSS) mode, as discussed herein (e.g., has an Access Point (AP) for the BSS and one or more stations (STAs) associated with the AP. The AP may have access or interface to a Distribution System (DS) or another type of wired/wireless network that carries traffic in and out of the BSS. Traffic to STAs that originates from outside the BSS may arrive through the AP and may be delivered to the STAs. Traffic originating from STAs to destinations outside the BSS may be sent to the AP to be delivered to the respective destinations.

Traffic between STAs within the BSS may also be sent through the AP where the source STA sends traffic to the AP and the AP delivers the traffic to the destination STA.

Using the 802.11ac infrastructure mode of operation, the AP may transmit a beacon on a fixed channel, usually the primary channel. This channel may be 20 MHz wide and is the operating channel of the BSS. This channel is also used by the STAs to establish a connection with the AP. The fundamental channel access mechanism in an 802.11 system is Carrier Sense Multiple Access with Collision Avoidance (CSMA/CA). In this mode of operation, every STA, including the AP, will sense the primary channel. If the channel is detected to be busy, the STA backs off. Hence only one STA may transmit at any given time in a given BSS.

In 802.11n, High Throughput (HT) STAs may also use a 40 MHz wide channel for communication. This is achieved by combining the primary 20 MHz channel, with an adjacent 20 MHz channel to form a 40 MHz wide contiguous channel.

In 802.11ac, Very High Throughput (VHT) STAs may support 20 MHz, 40 MHz, 80 MHz, and 160 MHz wide channels. The 40 MHz, and 80 MHz, channels are formed by combining contiguous 20 MHz channels similar to 802.11n described above. A160 MHz channel may be formed either by combining 8 contiguous 20 MHz channels, or by combining two non-contiguous 80 MHz channels, which may also be referred to as an 80+80 configuration. For the 80+80 configuration, the data, after channel encoding, is passed through a segment parser that divides it into two streams. The Inverse Discrete Fourier Transformation (IDFT) operation and time-domain processing is done on each stream separately. The streams are then mapped on to the two channels, and the data is transmitted. At the receiver, this mechanism is reversed, and the combined data is sent to the MAC.

To improve spectral efficiency 802.1 lac also includes the concept for downlink Multi-User MIMO (MU-MIMO) transmission to multiple STA's in the same symbol's time frame, such as during a downlink OFDM symbol. The potential for the use of downlink MU-MIMO is may also be a part of 802.11ah. It is important to note that since downlink MU-MIMO, as it is used in 802.11ac, uses the same symbol timing to multiple STA's, interference of the waveform transmissions to multiple STA's is not an issue. However, all STA's involved in MU-MIMO transmission with the AP may need to use the same channel or band, which may limit the operating bandwidth to the smallest channel bandwidth that is supported by the STA's, which are included in the MU-MIMO transmission with the AP.

In 802.11 Ultra High Reliability (UHR), there is the general goal to improve reliability of WLAN connectivity, reduced latencies, increased manageability, and increased throughput. One or more of the following features may be associated with and/or be included for 802.11 UHR: Supporting a maximum aggregated throughput of at least 100 Gbps; Supporting at least two times improvement in aggregated throughput at every signal to noise ratio (SNR) level (e.g., measured at the MAC data service access point) compared to 802.11be; Defining at least one mode of operation capable of improved latency bound and jitter at the 99 to 99.9999th percentiles compared to 802.11be; Satisfying real-time applications requirements for high reliability in the presence of overlapping BSSs and for seamless BSS transitions within an ESS; and/or, Enabling backward compatibility and coexistence with legacy 802.11 devices operating in license-exempt bands between 1 and 7.250 GHz and enabling coexistence with legacy 802.11 devices operating in license-exempt bands between 42.5 and 71 GHz.

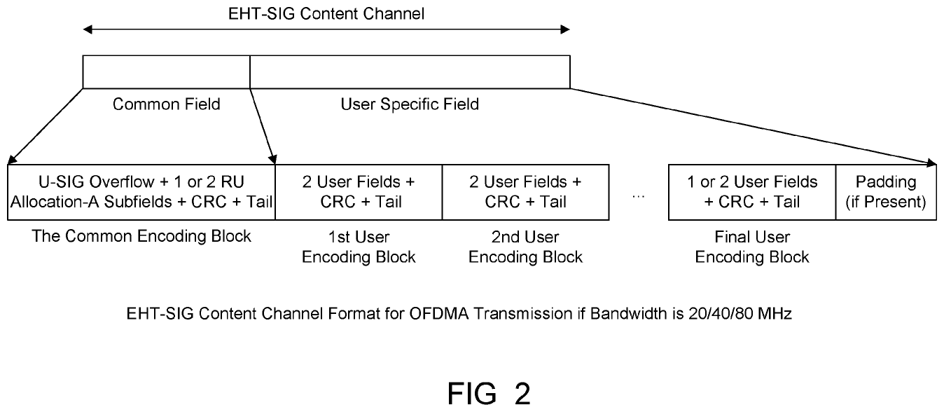

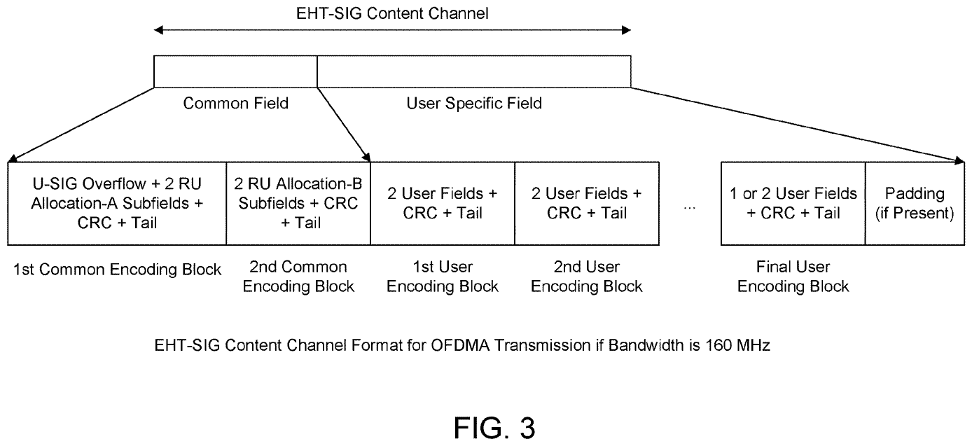

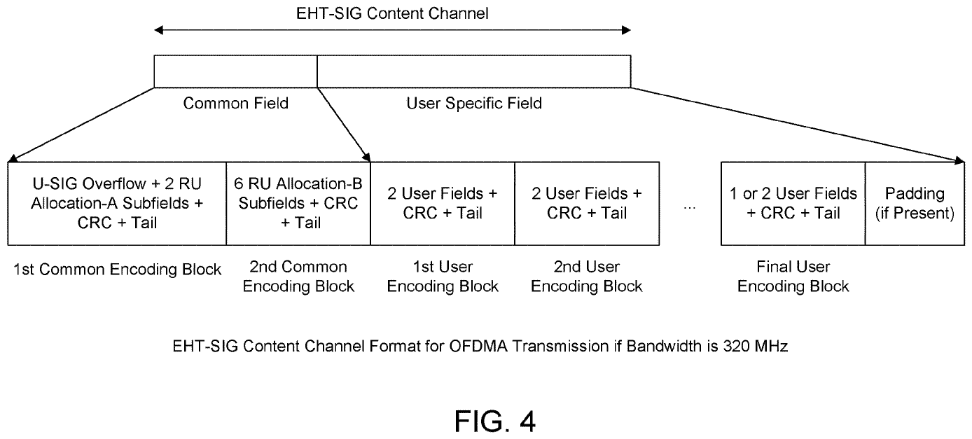

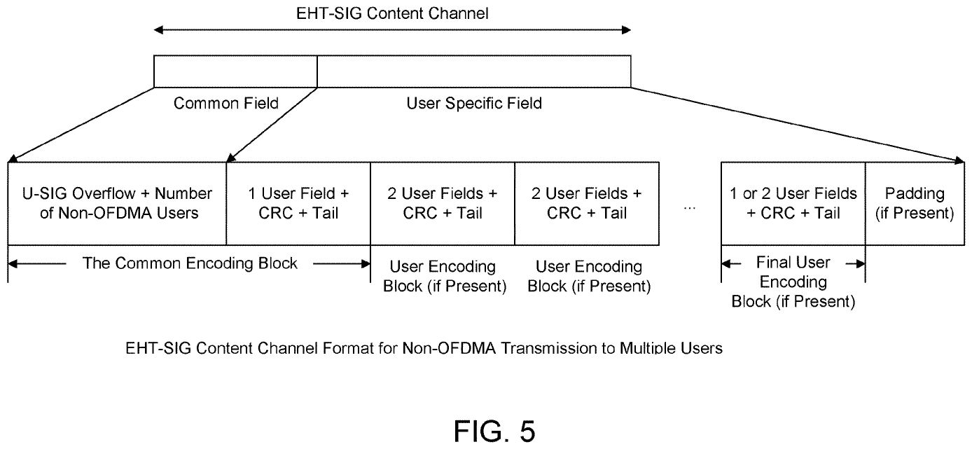

The Extremely High Throughput Signal (EHT-SIG) field is an example of a SIG filed that is used to provide signaling for the STAs to interpret the resource allocation in a Physical Layer Protocol Data Unity (PPDU). The EHT-SIG field of a 20 MHz EHT MU PPDU may comprise one EHT-SIG content channel. For OFDMA transmission and for non-OFDMA transmission to multiple users, the EHT-SIG field of an EHT MU PPDU that is 40 MHz or 80 MHz may comprise two EHT-SIG content channels. For OFDMA transmission and for non-OFDMA transmission to multiple users, the EHT-SIG field of an EHT MU PPDU that is 160 MHz or wider may comprise two EHT-SIG content channels per 80 MHz frequency subblock. The EHT-SIG content channels per 80 MHz frequency subblock may carry different information when EHT MU PPDU bandwidth for OFDMA transmission is wider than 80 MHz. The EHT-SIG field of an EHT SU transmission or the EHT-SIG field of an EHT sounding NDP may comprise one EHT-SIG content channel, and it may be duplicated in each non-punctured 20 MHz subchannel when the EHT PPDU is equal to or wider than 40 MHz. Different examples of the EHT-SIG content channels are depicted in FIG. 2, FIG. 3, FIG. 4, FIG. 5.

FIG. 2 illustrates an example of EHT-SIG content channel format for OFDMA transmission if bandwidth is 20/40/80 MHz; FIG. 3 illustrates an example of EHT-SIG content channel format for OFDMA transmission if bandwidth is 160 MHz; FIG. 4 illustrates an example of EHT-SIG content channel format for OFDMA transmission if bandwidth is 320 MHz; and FIG. 5 illustrates an example of EHT-SIG content channel format for non-OFDMA transmission to multiple users.

In a WLAN context, range extension refers to the methods and techniques that allow for providing Wi-Fi service at a farther distance from the AP such as repeated transmission (e.g., in frequency domain or in time domain), multi-AP operation, and/or relay transmission. Another method to extend the range may be to increase the transmit power but may not be as effective as other techniques due to the tough power spectral density (PSD) limitations in Wi-Fi. Since the PSD limitations are defined per MHz for each transmitting STA, the PSD limitations may be avoided by distributing the tones (subcarriers) of regular resource units (RUs) over a wider bandwidth that allows for higher transmit power for each individual tone (subcarrier), and extended range would follow. This new wide bandwidth resource unit may be referred to as a Tone-Distributed Resource Unit (TD-RU). Practical design of the tone plan, preamble, and signaling of the resource allocation of the TD-RUs is discussed further herein.

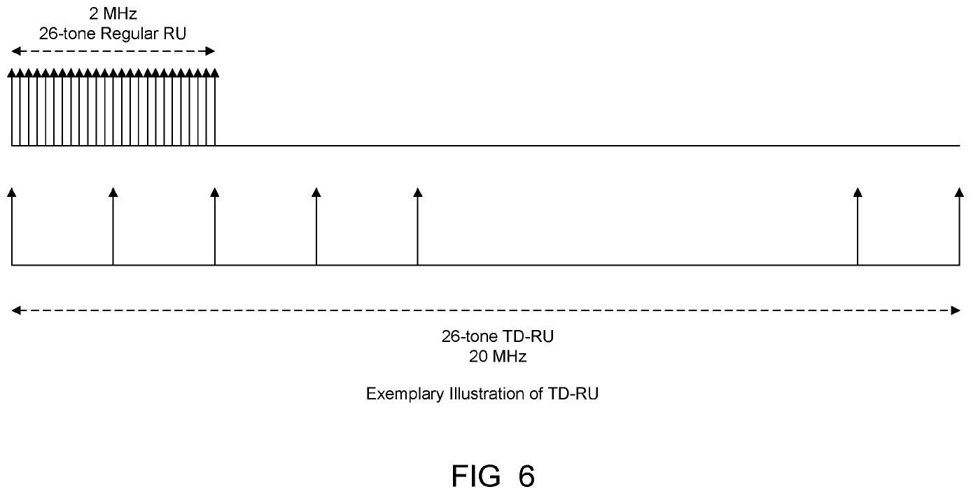

Generally, Tone-Distributed Resource Unit (TD-RU) refers to a resource unit (RU) whose subcarriers are distributed over a wider bandwidth (e.g., relative to legacy techniques which use regular RUs), which may be called the TD-RU bandwidth, compared to the regular RUs whose subcarriers are contiguous as illustrated in FIG. 6. Similarly, TD-MRU refers to Tone-Distributed Multiple Resource Unit. Accordingly, the transmit power may be boosted by a power boost gain (e.g., as compared to a regular RU) which may be calculated as:

$$Power Boost Gain = 10 log \frac{{N}_{r}}{{N}_{d}} dB$$

Where Nᵣ is the number of tones per MHz of the regular RU and N_{d} is the maximum number of tones per MHz of the TD-RU.

FIG. 6 illustrates an example of a regular RU, having 26 tones in a 2 MHZ bandwidth, that may be used to generate a 26-tone small TD-RU whose tones are distributed over a 20 MHz bandwidth. The TD-RU thus generated may be termed a small TD-RU because it represents a tone distribution from a regular RU where the regular RU has a contiguous cluster of individual tones in a 2 MHZ bandwidth. Thus, a regular RU, such as a 26-tone RU in 2 MHZ, may be arranged to have tones distributed in a wider bandwidth, such as 20 MHZ or 40 MHZ, to generate an individual small TD-RU according to an aspect of the disclosure.

In some cases, there may be one or more tone plans (an arrangement of tones) as it relates to a distributed tone organization/plan of a combination of individual small TD-RUs into a larger, combined TDRU.

In one case, the tone plan of the TD-RUs may be designed to minimize the number of tones per MHz to maximize the power boost gain. The tone plan of TD-RUs may be also designed to minimize the TD-RU bandwidth in which the tones of the RU may be distributed after which no power boosting gain can be achieved. Also, the tone plan of the TD-RUs may be designed to minimize the Inter-Carrier Interference (ICI) between different users. In what follows and in part what preceded, different examples of tone plans designed to achieve these goals are explained.

In one case, the bandwidth in which a TD-RU may be distributed, named as TD-RU bandwidth, may be upper bounded by the BSS operating bandwidth as signaled in the Bandwidth field of a SIG field. In one example, the TD-RU bandwidth of 26-tone RU transmitted in a PPDU with the SIG field in the preamble indicating a Bandwidth of 80 MHz may be 20 MHz, 40 MHz, 60 MHz, or 80 MHz.

In one case, 26-tone, 52-tone, and 106-tone TD-RUs may be defined where the tones of the TD-RU may be distributed over a TD-RU bandwidth such as 20 MHz, 40 MHz, 80 MHz, or any larger bandwidth.

In one case, 52+26-tone and 106+26-tone TD-MRUs may be defined where the tones of the TD-MRU may be distributed over an TD-RU bandwidth such as 20 MHz, 40 MHz, 80 MHz, or any wider bandwidth.

In one case, 242-tone, 484-tone, and 996-tone TD-RUs may be defined where the tones of the TD-RU may be distributed over an TD-RU bandwidth such as 40 MHz, 80 MHz, 160 MHz, or any wider bandwidth.

In one case, 484+242-tone and 996+484-tone TD-MRUs may be defined where the tones of the TD-MRU may be distributed over an TD-RU bandwidth such as 160 MHz, 320 MHz, or any wider bandwidth.

In one case, the tone plan of a TD-RU shall be symmetric in the TD-RU bandwidth to avoid I/Q imbalance. In one example, the tones of a 26-tone TD-RU in a TD-RU bandwidth of 20 MHz may be allocated such that 13 tones are distributed in the lower 10 MHz in any distribution as suggested by the tone plans proposed in the following embodiments and the other 13 tones are distributed in the upper 10 MHz using subcarrier indices that are symmetrical with the subcarrier indices of the 13 tones in the lower 10 MHz.

In some cases, there may be a 26-tone TD-RU tone plan used.

In one case, the tone plan of a 26-tone RU may be designed to maximize the power boost gain, minimize the TD-RU bandwidth, and/or minimize the ICI between different STAs. The maximum achievable power boost gain for 26-tone TD-RU in an TD-RU bandwidth of 20 MHz is 10 log=8.13 dB since the number of the tones per MHz of a regular RU is 13 and the minimum number of tones per MHz of the 26-tone TD-RU is 2. The maximum achievable power boost gain for 26-tone TD-RU in an TD-RU bandwidth of 40 MHz or wider may be 10 log=11.14 dB.

In one case, the subcarriers of a 26-tone TD-RU in a 20 MHz bandwidth may be located such that each one MHz contains one tone while the extra tones (e.g., 6 subcarriers) are distributed in any combination over the 20 MHz such that the maximum tones per MHz does not exceed 2 tones to achieve the maximum power boost gain.

In one case, the subcarriers of a 26-tone TD-RU in a 20 MHz bandwidth may be located such that the 26 subcarriers are grouped in 13 groups each of 2 subcarriers and each group is mapped to one MHz of the 20 MHz of the TD-RU bandwidth in any combination. This plan achieves a power boost gain of 8.13 dB while at the same time uses only 13 MHz of the 20 MHz of the TD-RU bandwidth leaving more room for the allocation of other 26-tone TD-RUs in the same TD-RU bandwidth to minimize the ICI between different TD-RUs.

In one case, the subcarriers of a 26-tone TD-RU in a 20 MHz bandwidth may be located such that the 26 subcarriers are grouped in 9 groups; 8 groups each of 3 subcarriers and 1 group of 2 subcarriers. Each group is mapped to one MHz of the 20 MHz of the TD-RU bandwidth in any combination. This plan achieves a power boost gain of 6.37 dB while at the same time uses only 9 MHz of the 20 MHz of the TD-RU bandwidth leaving more room for the allocation of other 26-tone TD-RUs in the same TD-RU bandwidth to minimize the ICI between different TD-RUs.

In one case, the subcarriers of a 26-tone TD-RU in a 20 MHz bandwidth may be located such that the 26 subcarriers are grouped in 7 groups; 6 groups each of 4 subcarriers and 1 group of 2 subcarriers. Each group is mapped to one MHz of the 20 MHz of the TD-RU bandwidth in any combination. This plan achieves a power boost gain of 5.12 dB while at the same time uses only 7 MHz of the 20 MHz of the TD-RU bandwidth leaving more room for the allocation of other 26-tone TD-RUs in the same TD-RU bandwidth to minimize the ICI between different TD-RUs.

In one case, the subcarriers of a 26-tone TD-RU in a 20 MHz bandwidth may be located such that the 26 subcarriers are grouped in 6 groups; 5 groups each of 5 subcarriers and 1 group of 1 subcarrier. Each group is mapped to one MHz of the 20 MHz of the TD-RU bandwidth in any combination. This plan achieves a power boost gain of 4.15 dB while at the same time uses only 6 MHz of the 20 MHz of the TD-RU bandwidth leaving more room for the allocation of other 26-tone TD-RUs in the same TD-RU bandwidth to minimize the ICI between different TD-RUs.

In one case, the lower bound of grouping of the 26 subcarriers of a 26-tone TD-RU in a 20 MHz bandwidth is 2 groups each of 13 subcarriers achieving a power boost gain of 0 dB, thus not useful for the range extension purpose. A regular RU would fall under this scenario where the two groups of 13 subcarriers are next to each other. Example combinations of 26-tone TD-RU in 20 MHz are listed in Table 1.

TABLE 1
Example Combinations of 26-tone TD-RU in 20 MHz

| | | Number | Power | |
|---|---|---|---|---|
| Combination | | of | Boost | |
| Index | Grouping of the Subcarriers | Groups | Gain | |
| 0 | 26-tone group (Regular RU) | 1 | 0 | dB |
| 1 | 2 groups of 13 subcarriers each 2 × 13-tone | 2 | 0 | dB |
| 2 | 3 groups of 8 subcarriers each + 1 group of 2 subcarriers | 4 | 2.11 | dB |
| | 3 × 8-tone + 1 × 2-tone | | | |
| 3 | 4 groups of 6 subcarriers each + 1 group of 2 subcarriers | 5 | 3.36 | dB |
| | 4 × 6-tone + 1 × 2-tone | | | |
| 4 | 5 groups of 5 subcarriers each + a group of 1 subcarrier | 6 | 4.15 | dB |
| | 5 × 5-tone + 1 × 1-tone | | | |
| 5 | 6 groups of 4 subcarriers each + 1 group of 2 subcarrier | 7 | 5.12 | dB |
| | 6 × 4-tone + 1 × 2-tone | | | |
| 6 | 8 groups of 3 subcarriers each + 1 group of 2 subcarrier | 9 | 6.37 | dB |
| | 8 × 3-tone + 1 × 2-tone | | | |
| 7 | 13 groups of 2 subcarriers each 13 × 2-tone | 13 | 8.13 | dB |
| 8 | 14 groups of 1 subcarrier each + 6 groups of 2 subcarrier | 20 | 8.13 | dB |

each 14 × 1-tone + 6 × 2-tone

In one case, the subcarriers of a 26-tone TD-RU in a 40 MHz bandwidth may be located such that the same combinations for 20 MHz bandwidth TD-RU bandwidth are valid combinations for a 40 MHz TD-RU bandwidth.

In one case, the subcarriers of a 26-tone TD-RU in a 40 MHz bandwidth may be located such that the 26 subcarriers are grouped in 21 groups: 16 groups each of 1 subcarrier and 5 groups each of 2 subcarriers. Each group is mapped to one MHz of the 40 MHz of the TD-RU bandwidth in any combination. This plan achieves a power boost gain of 8.13 dB while at the same time uses only 21 MHz of the 40 MHz of the TD-RU bandwidth leaving more room for the allocation of other 26-tone TD-RUs in the same TD-RU bandwidth to minimize the ICI between different TD-RUs.

In one case, the subcarriers of a 26-tone TD-RU in a 40 MHz bandwidth may be located such that the 26 subcarriers are grouped in 22 groups: 18 groups each of 1 subcarrier and 4 groups each of 2 subcarriers. Each group is mapped to one MHz of the 40 MHz of the TD-RU bandwidth in any combination. This plan achieves a power boost gain of 8.13 dB while at the same time uses only 21 MHz of the 40 MHz of the TD-RU bandwidth leaving more room for the allocation of other 26-tone TD-RUs in the same TD-RU bandwidth to minimize the ICI between different TD-RUs. Example combinations of 26-tone TD-RU in 40 MHz are listed in Table 2.

TABLE 2
Example Combinations of 26-tone TD-RU in 40 MHz

| | | Number | Power | |
|---|---|---|---|---|
| Combination | | of | Boost | |
| Index | Grouping of the Subcarriers | Groups | Gain | |
| 9 | 16 groups of 1 subcarrier each + 5 groups of 2 | 21 | 8.13 | dB |
| | subcarrier each 16 × 1-tone + 5 × 2-tone | | | |
| 10 | 18 groups of 1 subcarrier each + 4 groups of 2 | 22 | 8.13 | dB |
| | subcarrier each 18 × 1-tone + 4 × 2-tone | | | |
| 11 | 20 groups of 1 subcarrier each + 3 groups of 2 | 23 | 8.13 | dB |
| | subcarrier each 20 × 1-tone + 3 × 2-tone | | | |
| 12 | 22 groups of 1 subcarrier each + 2 groups of 2 | 24 | 8.13 | dB |
| | subcarrier each 22 × 1-tone + 2 × 2-tone | | | |
| 13 | 24 groups of 1 subcarrier each + 1 groups of 2 | 25 | 8.13 | dB |
| | subcarrier each 24 × 1-tone + 1 × 2-tone | | | |
| 14 | 26 groups of 1 subcarrier each 26 × 1-tone | 26 | 11.14 | dB |

In some cases, there may be a 52-tone TD-RU tone plan.

In one embodiment, the tone plan of a 52-tone RU may be designed to maximize the power boost gain, minimize the TD-RU bandwidth, and minimize the ICI between different STAs. The maximum achievable power boost gain for 52-tone TD-RU in an TD-RU bandwidth of 20 MHz is 10 log 13/3=6.37 dB since the number of the tones per MHz of a regular RU is 13 and the minimum number of tones per MHz of the 52-tone TD-RU is 3. The maximum achievable power boost gain for 52-tone TD-RU in an TD-RU bandwidth of 40 MHz is 10 log 13/2=8.13 dB and the maximum achievable power boost gain for 52-tone TD-RU in an TD-RU bandwidth of 80 MHz or wider is 10 log 13/1=11.14 dB. Example combinations of 52-tone TD-RU in 20 MHz are listed in Table 3, example combinations of 52-tone TD-RU in 40 MHz are listed in Table 4, and example combinations of 52-tone TD-RU in 80 MHz are listed in Table 5.

TABLE 3
Example Combinations of 52-tone TD-RU in 20 MHz

| | | Number | Power | |
|---|---|---|---|---|
| Combination | | of | Boost | |
| Index | Grouping of the Subcarriers | Groups | Gain | |
| 0 | 52-tone group (Regular RU) | 1 | 0 | dB |
| 1 | 2 groups of 26 subcarriers each 2 × 26-tone | 2 | 0 | dB |
| 2 | 4 groups of 13 subcarriers each 4 × 13-tone | 4 | 0 | dB |
| 3 | 5 groups of 10 subcarriers each + 1 group of 2 | 6 | 1.14 | dB |
| | subcarriers 5 × 10-tone + 1 × 2-tone | | | |
| 4 | 6 groups of 8 subcarriers each + 1 group of 4 | 7 | 2.11 | dB |
| | subcarriers 6 × 8-tone + 1 × 4-tone | | | |
| 5 | 7 groups of 7 subcarriers each + 1 group of 3 | 8 | 2.69 | dB |
| | subcarriers 7 × 7-tone + 1 × 3-tone | | | |
| 6 | 8 groups of 6 subcarriers each + 1 group of 4 | 9 | 3.36 | dB |
| | subcarriers 8 × 6-tone + 1 × 4-tone | | | |
| 7 | 10 groups of 5 subcarriers each + 1 group of 2 | 11 | 4.15 | dB |
| | subcarriers 10 × 5-tone + 1 × 2-tone | | | |
| 8 | 13 groups of 4 subcarriers each 13 × 4-tone | 13 | 5.12 | dB |
| 9 | 17 groups of 3 subcarriers each + 1 group of 1 | 18 | 6.37 | dB |

subcarrier 17 × 3-tone + 1 × 1-tone

TABLE 4
Example Combinations of 52-tone TD-RU in 40 MHz

| | | Number | Power |
|---|---|---|---|
| Combination | | of | Boost |
| Index | Grouping of the Subcarriers | Groups | Gain |
| 10 | 26 groups of 2 subcarrier each 26 × 2-tone | 26 | 8.13 dB |
| 11 | 28 groups of 1 subcarrier each + 12 groups of 2 | 40 | 8.13 dB |
| | subcarriers each 28 × 1-tone + 12 × 2-tone | | |

TABLE 5
Example Combinations of 52-tone TD-RU in 80 MHz

| | | Number | Power | |
|---|---|---|---|---|
| Combination | | of | Boost | |
| Index | Grouping of the Subcarriers | Groups | Gain | |
| 12 | 30 groups of 1 subcarrier each + 11 groups of 2 | 41 | 8.13 | dB |
| | subcarriers each 30 × 1-tone + 11 × 2-tone | | | |
| 13 | 32 groups of 1 subcarrier each + 10 groups of 2 | 42 | 8.13 | dB |
| | subcarriers each 32 × 1-tone + 10 × 2-tone | | | |
| 14 | 34 groups of 1 subcarrier each + 9 groups of 2 | 43 | 8.13 | dB |
| | subcarriers each 34 × 1-tone + 9 × 2-tone | | | |
| 15 | 36 groups of 1 subcarrier each + 8 groups of 2 | 44 | 8.13 | dB |
| | subcarriers each 36 × 1-tone + 8 × 2-tone | | | |
| 16 | 38 groups of 1 subcarrier each + 7 groups of 2 | 45 | 8.13 | dB |
| | subcarriers each 38 × 1-tone + 7 × 2-tone | | | |
| 17 | 40 groups of 1 subcarrier each + 6 groups of 2 | 46 | 8.13 | dB |
| | subcarriers each 40 × 1-tone + 6 × 2-tone | | | |
| 18 | 42 groups of 1 subcarrier each + 5 groups of 2 | 47 | 8.13 | dB |
| | subcarriers each 42 × 1-tone + 5 × 2-tone | | | |
| 19 | 44 groups of 1 subcarrier each + 4 groups of 2 | 48 | 8.13 | dB |
| | subcarriers each 44 × 1-tone + 4 × 2-tone | | | |
| 20 | 46 groups of 1 subcarrier each + 3 groups of 2 | 49 | 8.13 | dB |
| | subcarriers each 46 × 1-tone + 3 × 2-tone | | | |
| 21 | 48 groups of 1 subcarrier each + 2 groups of 2 | 50 | 8.13 | dB |
| | subcarriers each 48 × 1-tone + 2 × 2-tone | | | |
| 22 | 50 groups of 1 subcarrier each + 1 groups of 2 | 51 | 8.13 | dB |
| | subcarriers each 50 × 1-tone + 1 × 2-tone | | | |
| 23 | 52 groups of 1 subcarrier each 52 × 1-tone | 52 | 11.14 | dB |

In some cases, there may be a 106-tone TD-RU tone plan.

In one case, the tone plan of a 106-tone RU may be designed to maximize the power boost gain, minimize the TD-RU bandwidth, and minimize the ICI between different STAs. The maximum achievable power boost gain for 106-tone TD-RU in an TD-RU bandwidth of 20 MHz is 10 log 13/6=3.36 dB since the number of the tones per MHz of a regular RU is 13 and the minimum number of tones per MHz of the 106-tone TD-RU is 6. The maximum achievable power boost gain for 106-tone TD-RU in an TD-RU bandwidth of 40 MHz is 10 log 13/3=6.37 dB and the maximum achievable power boost gain for 106-tone TD-RU in an TD-RU bandwidth of 80 MHz is 10 log 13/2=8.13 dB. Example combinations of 106-tone TD-RU in 20 MHz are listed in Table 6, example combinations of 106-tone TD-RU in 40 MHz are listed in Table 7, and example combinations of 106-tone TD-RU in 80 MHz are listed in Table 8.

In one case, the subcarriers of a 106-tone TD-RU may be located such that the same combinations for 20 MHz TD-RU bandwidth are valid combinations for a 40 or 80 MHz TD-RU bandwidth and the same combinations for 40 MHz are valid combinations for 80 MHz TD-RU bandwidth.

TABLE 6
Example Combinations of 106-tone TD-RU in 20 MHz

| | | Number | Power | |
|---|---|---|---|---|
| Combination | | of | Boost | |
| Index | Grouping of the Subcarriers | Groups | Gain | |
| 0 | 106-tone group (Regular RU) | 1 | 0 | dB |
| 1 | 8 groups of 13 subcarriers each + 1 group of 2 | 9 | 0 | dB |
| | subcarriers 8 × 13-tone + 1 × 2-tone | | | |
| 2 | 10 groups of 10 subcarriers each + 1 group of 6 | 11 | 1.14 | dB |
| | subcarriers 10 × 10-tone + 1 × 6-tone | | | |
| 3 | 13 groups of 8 subcarriers each + 1 group of 2 | 14 | 2.11 | dB |
| | subcarriers 13 × 8-tone + 1 × 2-tone | | | |
| 4 | 17 groups of 6 subcarriers each + 1 group of 4 | 18 | 3.36 | dB |

subcarriers 17 × 6-tone + 1 × 4-tone

TABLE 7
Example Combinations of 106-tone TD-RU in 40 MHz

| | | Number | Power |
|---|---|---|---|
| Combination | | of | Boost |
| Index | Grouping of the Subcarriers | Groups | Gain |
| 5 | 26 groups of 4 subcarriers each + 1 group of 2 | 27 | 5.12 dB |
| | subcarriers 26 × 4-tone + 1 × 2-tone | | |
| 6 | 35 groups of 3 subcarriers each + 1 group of 1 | 37 | 6.37 dB |
| | subcarrier 35 × 3-tone + 1 × 1-tone | | |

TABLE 8
Example Combinations of 106-tone TD-RU in 80 MHz

| | | Number | Power |
|---|---|---|---|
| Combination | | of | Boost |
| Index | Grouping of the Subcarriers | Groups | Gain |
| 7 | 53 groups of 2 subcarriers each 53 × 2-tone | 53 | 8.13 dB |
| 8 | 54 groups of 1 subcarrier each + 26 groups of 2 | 80 | 8.13 dB |
| | subcarriers each 54 × 1-tone + 26 × 2-tone | | |

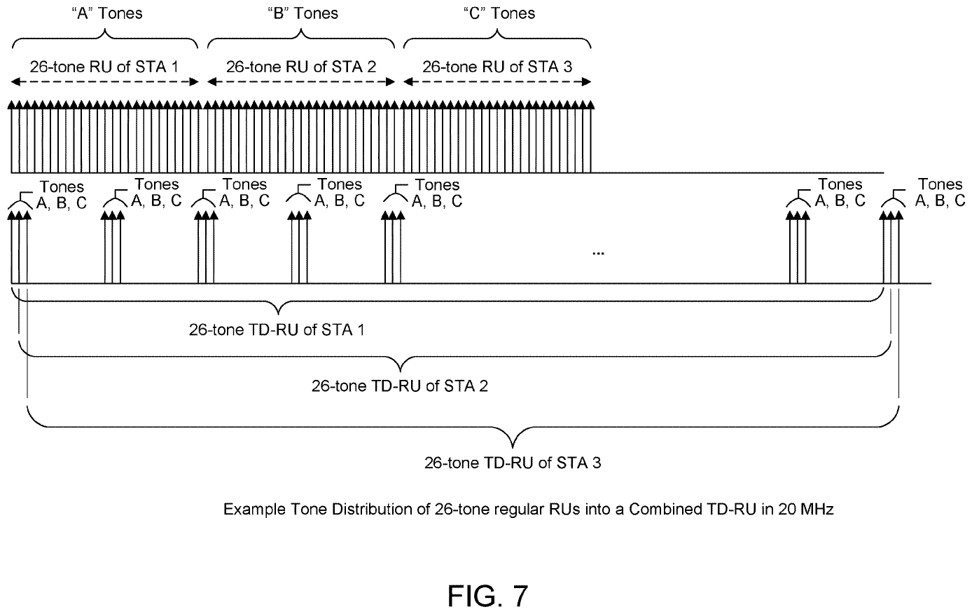

FIG. 7 illustrates an example of tone distribution of 26-tone small TD-RUs into 20 MHz. In this example, multiple regular RUs are shown, each having 26 consecutive or clustered tones in a 2 MHZ bandwidth. For example, there is a regular RU for STA 1 having 26 tones, simply labeled as “A” tones. Another regular RU is shown for STA 2 as having 26 tones in a 2 MHZ bandwidth simply labeled “B” tones. Another regular RU is shown for STA 3 as having 26 tones in a 2 MHZ bandwidth simply labeled “C” tones. The A, B, and C tones may each be distributed as small TD-RUs in a wider 20 MHZ bandwidth. Collectively, the combination of small TD-RUs in the 20 MHz bandwidth may be termed a combined TD-RU. As used herein, the term small TD-RU may be interchangeably termed TD-RU. The assembly/plan/organization of an aggregation of multiple small TD-RUs into a larger TD-RU is termed a combined TD-RU herein. Generically, it is noted that TD-RU refers to a RU whose subcarriers are distributed over a wider bandwidth.

In one case, the tones of a small TD-RU may be distributed such that the tones of the small TD-RU allocated to STA 1 are positioned next to the tones of the small TD-RU allocated to STA 2 which are positioned next to the tones of the small TD-RU allocated to STA 3 as shown in FIG. 7. In FIG. 7, the tones of STA 1 may be indicated as “A” tones, the tones of STA 2 may be indicated as “B” tones, the tones of STA 3 may be indicated as “C” tones. This tone allocation (tones A, B, and C) may maximize the bandwidth utilization since all the subcarriers will be allocated to STAs in the combined TD-RU. However, the transmitted signal from STA 1 over the tones of the TD-RU1 (“A” tones) may, in certain circumstances, cause interference to the transmitted signal from STA 2 over the tones of the TD-RU2 (“B” tones) due to the lack of perfect synchronization and power control between STA 1 and STA 2.

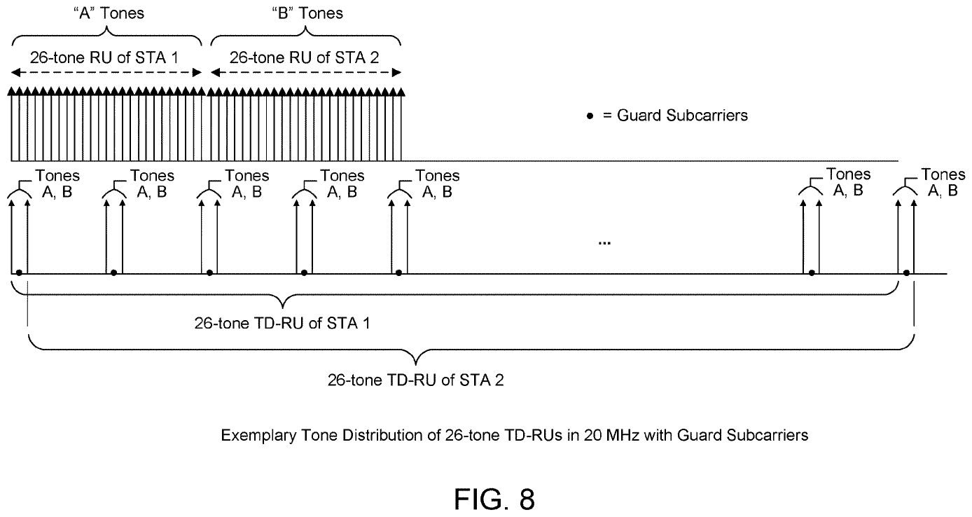

FIG. 8 illustrates an example of tone distribution of two 26-tone small TD-RUs into a 20 MHz combined TD-RU with guard subcarriers preamble design.

In one case, the tones of a TD-RU may be distributed such that the tones of the TD-RU are positioned such that one or more subcarriers are left null as guard subcarriers between the tones of the TD-RU allocated to STA 1 and the tones of the TD-RU allocated to STA 2 as shown in FIG. 8. In FIG. 8, the null guard subcarriers are indicated as dots between the A, B tones. This tone plan may reduce the inter-carrier interference (ICI) between the tones of TD-RU1 and TD-RU2, however, the number of TD-RUs per 20 MHz may be less than the number of regular RUs per 20 MHz due to the unutilized subcarriers used as guard tones.

In one case, there may be a need for modified or specific preamble design to accommodate the integration of small TD-RUs into a combined TD-RU. A TD-RU may be defined by 4 parameters: F is the subcarrier index of the first tone of the TD-RU, Tis the number of tones in each group of tones comprising the TD-RU, G is the gap between each group of tones measured in number of subcarriers, and P is the set of pilot tones of the TD-RU.

In one example tone plan, nine 26-tone small TD-RUs may be structured by allocating the tones of a 20 MHz subchannel such that the first tone is allocated to the first small TD-RU, the second tone is allocated to the second small TD-RU, and so on until the ninth tone is allocated to the ninth small TD-RU. Then, the tenth tone is allocated to the first small TD-RU, the eleventh tone is allocated to the second small TD-RU and so on. In general, each next 9 tones are allocated to the nine small TD-RUs in turn until each small TD-RU is structured with 26 distributed tones in the 20 MHz subchannel arrangement of a combined TD-RU. FIG. 7 depicts an example tone distribution of a 26 tone TD-RU in a 20 MHz bandwidth. For simplicity, the example of FIG. 7 shows 3 regular RUs (i.e. each 26-tone RU of a STA 1, STA 2, and STA 3) of the 9 regular RUs described above. The 4 parameters of each TD-RU could be accordingly characterized as in Table 9.

TABLE 9
Example Characterization of Different TD-RU Tone Plan Designs

| TD-RU Index | F | T | G | P | Subcarriers List |
|---|---|---|---|---|---|
| 1 | −121 | 1 | 9 | {−67, 58} | [−121:9:−5, 4:9:112] |
| 2 | −120 | 1 | 9 | {−66, 59} | [−120:9:−4, 5:9:113] |
| 3 | −119 | 1 | 9 | {−65, 60} | [−119:9:−4, 6:9:114] |
| 4 | −118 | 1 | 9 | {−64, 61} | [−118:9:−4, 7:9:115] |
| 5 | −117 | 1 | 9 | {−63, 62} | [−117:9:−4, 8:9:116] |
| 6 | −116 | 1 | 9 | {−62, 63} | [−116:9:−4, 9:9:117] |
| 7 | −115 | 1 | 9 | {−61, 64} | [−115:9:−4, 10:9:118] |
| 8 | −114 | 1 | 9 | {−60, 65} | [−114:9:−4, 11:9:119] |
| 9 | −113 | 1 | 9 | {−59, 66} | [−113:9:−4, 12:9:120] |

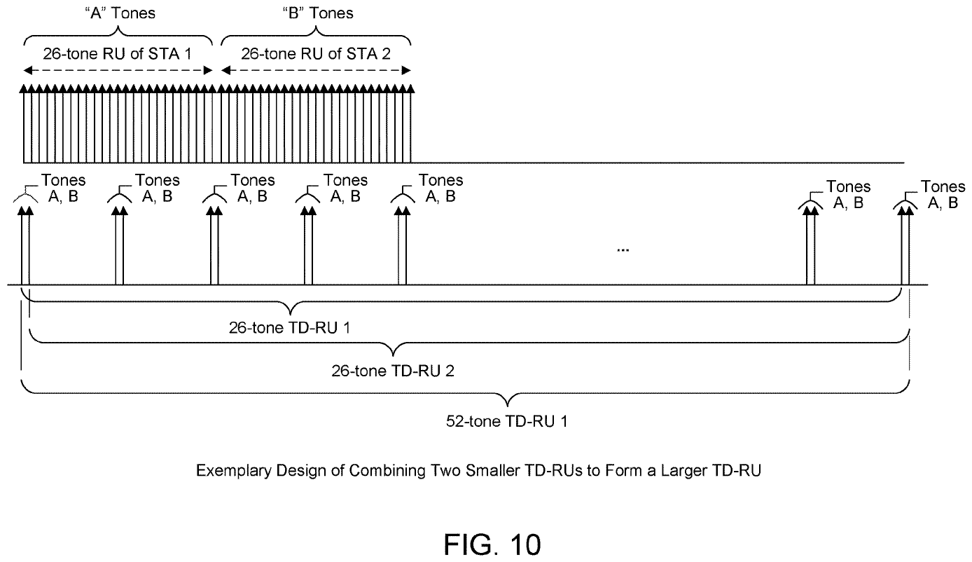

FIG. 10 illustrates an example design of combining two smaller TD-RUs to form a larger TD-RU.

In one case, the tone plan of smaller TD-RUs may be designed such that a larger TD-RU (i.e. a combined TD-RU) may be composed of small TD-RUs. In one example, a one 52-tone combined TD-RU may be composed by combining two 26-tone small TD-RUs as illustrated in FIG. 10. In FIG. 10, a 26-tone regular RU of STA 1 and a 26 tone regular RU of STA 2 are arranged in a 52 tone combined TD-RU in an A, B group across the entire 52 tone bandwidth. In another example, a one 106-tone combined TD-RU may be composed by combining two 52-tone combined TD-RUs. Alternatively, or additionally, a one 106-tone combined TD-RU may be composed by combining four 26-tone small TD-RUs.

In one case, the pilot tones of a larger combined TD-RU may be the same pilot tones combined of the smaller TD-RUs which are used to compose the larger combined TD-RU. In one example, the pilot tones of a 26-tone small TD-RU combined with the pilot tones of another 26-tone small TD-RU may be used as the pilot tones of a 52-tone combined TD-RU.

In one embodiment, two or more non-consecutive small TD-RUs may be combined to form a larger combined TD-RU such that the pilot tones of the larger combined TD-RU (which are the combined pilot tones of the smaller TD-RUs) be distributed in the combined TD-RU bandwidth farther apart from each other. In one example, TD-RU26 #1 can be combined with TD-RU26 #6 to form TD-RU52 #1, TD-RU26 #2 can be combined with TD-RU26 #7 to form TD-RU52 #2 and so on as illustrated in Method 2 in Table 10. In another example, TD-RU52 #1 can be combined with TD-RU52 #3 to form TD-RU106 #1 and TD-RU52 #2 can be combined with TD-RU52 #3 to form TD-RU106 #4.

In another embodiment, the tones of the consecutive TD-RU26 #1 and TD-RU26 #2 can be chosen such that they are farther away from each other such that when they are combined, they form a larger TD-RU with the pilots of the larger TD-RU are farther apart from each other as illustrated in Method 1 in Table 10.

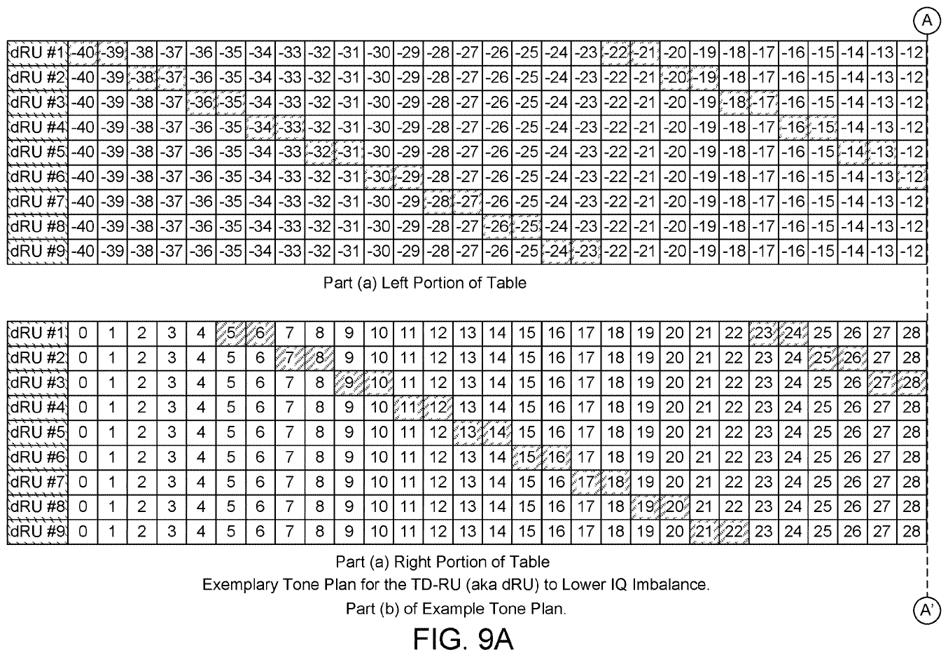

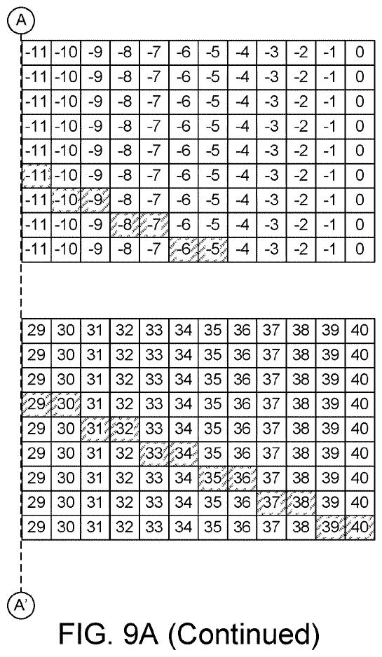

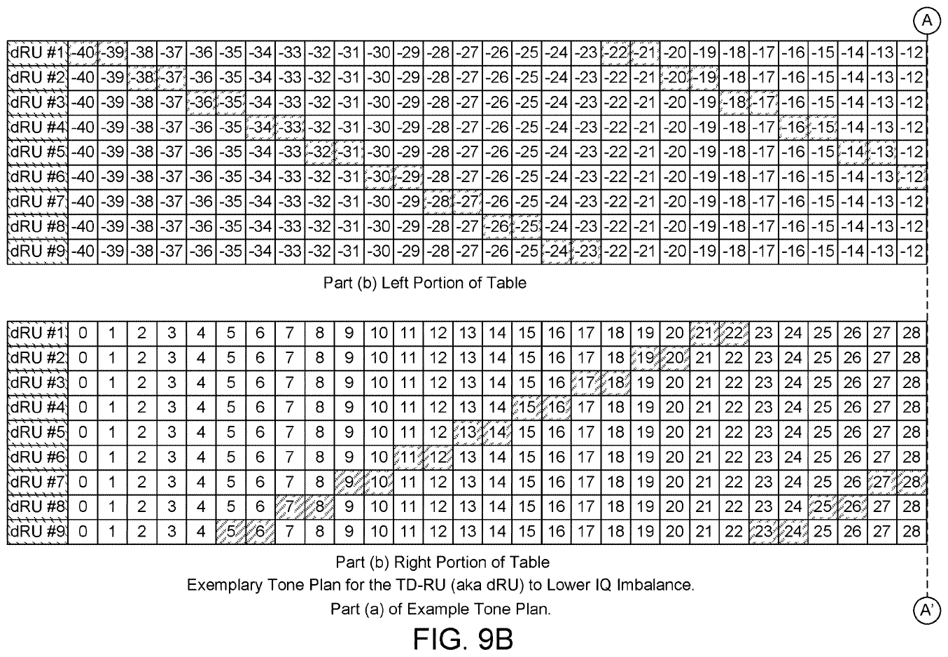

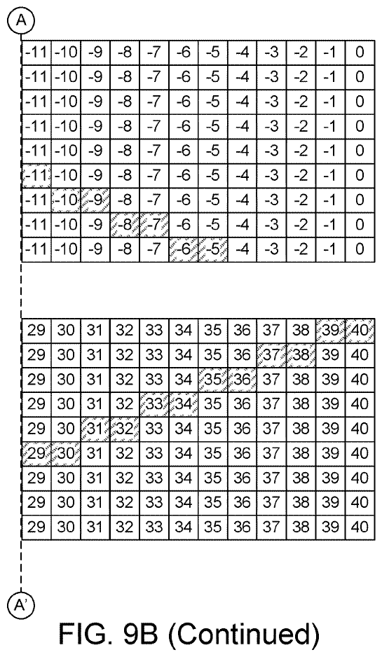

In one embodiment, the tone plan for a TD-RU (also known as a dRU) may be chosen to lower the IQ imbalance by allocating symmetric tones for the same TD-RU around the DC tone as illustrated in FIG. 9A. In one example, in FIG. 9A, TD-RU1 is allocated tones (−39, −40) (Part (a) Left Portion of Table), and (39,40) (Part (a) Right Portion of Table), around the DC tone instead of (See FIG. 9B) being allocated tones (−39,−40) (Part (b) Left Portion of Table), and (23,24) (Part (b) Right Portion of Table), as illustrated in FIG. 9B which may help in lowering the IQ imbalance. In another example, in FIG. 9A, TD-RU1 is allocated tones (−21, −22) (Part (a) Left Portion of Table), and (21,22) (Part (a) Right Portion of Table), around the DC tone instead of (See FIG. 9B) being allocated tones (−21,−22) (Part (b) Left Portion of Table), and (5,6) (Part (b) Right Portion of Table), as illustrated in FIG. 9B.

In one case, a larger TD-RU distributed over a larger bandwidth may be composed of two or more smaller TD-RUs each distributed over a smaller bandwidth. In one example, a 26-tone small TD-RU distributed over a channel of 20 MHz may be combined with another 26-tone small TD-RU distributed over another channel of 20 MHz to form a 52-tone combined TD-RU distributed over a channel of 40 MHz.

TABLE 10
Example Design of Combining two Smaller TD-RUs to form a larger
TD-RU with the pilots are chosen farther apart from each other.

| Combining consecutive | | | Combining non-consecutive | |
|---|---|---|---|---|
| smaller TD-RUs to form | | | smaller TD-RUs to form | |
| larger TD-RUs Method 1 | | | larger TD-RUs Method 2 | |
| TD- | TD- | TD- | TD- | TD- |
| RU26 #1 | RU52 #1 | RU106 #1 | RU26 #1 | RU52 #1 |
| TD- | | | TD- | |
| RU26 #2 | | | RU26 #6 | |
| TD- | TD- | | TD- | TD- |
| RU26 #3 | RU52 #2 | | RU26 #2 | RU52 #2 |
| TD- | | | TD- | |
| RU26 #4 | | | RU26 #7 | |
| TD- | | | TD- | |
| RU26 #5 | | | RU26 #5 | |
| TD- | TD- | TD- | TD- | TD- |
| RU26 #6 | RU52 #3 | RU106 #2 | RU26 #3 | RU52 #3 |
| TD- | | | TD- | |
| RU26 #7 | | | RU26 #8 | |
| TD- | TD- | | TD- | TD- |
| RU26 #8 | RU52 #4 | | RU26 #4 | RU52 #4 |
| TD- | | | TD- | |
| RU26 #9 | | | RU26 #9 | |

In one case, the tone plan of a TD-RU may be designed such that a different grouping of the tones may take place for different Modulation and Coding Scheme (MCS). In one example, a 26-tone TD-RU may be grouped in 12 groups each of 2 tones in addition to 2 pilot tones for MCS range 0 to 4 and may be grouped in 8 groups each of 3 tones in addition to 2 pilot tones for MCS range 5 to 8. In this case, the current grouping of the tones in the TD-RU may be signaled in the SIG field.

In one case, the users/STAs allocated TD-RUs may be grouped based on the MCS such that a group of users who are allocated the same MCS, or MCSs in the same range, may be assigned the same grouping for the TD-RUs and be allocated TD-RUs in the same channel (e.g., the same 20 MHz channel).

In one case, to minimize the interference between different STAs, different STAs may use different grouped TD-RU combinations listed in Tables 1, 2, 3, 4, and/or 5 as disclosed herein, such that, the existing pilot tones of the regular RUs can be utilized for all STAs. In one example, for 20 lVUz bandwidth, nine 26 tone TD-RUs may be characterized by Table 11.

TABLE 11
Example Design of the Tone Plan

| TD- | Grouping | |
|---|---|---|
| RU | of | Subcarrier Indices |
| Index | subcarriers | (Bold indicates the pilot indices) |
| 1 | 8 × 2 + 10 × 1 | {−116} {−95 −94} {−82} {−77} {−59 −58} {−41 −40} {−23} {−19} |
| | | {−5 −4} {4} {10} {23 24} {40 41} {58 59} {69} {77} {94 95} {113} |
| 2 | 10 × 2 + 6 × 1 | {−114} {−102} {−96} {−79 −78} {−61 −60} {−43 −42} {−25 −24} |
| | | {−7 −6} {6 7} {22} {25} {42 43} {60 61} {78 79} {96 97} {114} |
| 3 | 8 × 2 + 10 × 1 | {−115} {−99} {−90} {−81 −80} {−66} {−63} {−45 −44} {−27 −26} |
| | | {−9 −8} {8 9} {26 27} {36} {45} {63} {66} {80 81} {98 99} {115} |
| 4 | 8 × 2 + 10 × 1 | {−113} {−101 −100} {−83} {−76} {−65 −64} {−47 −46} {−29 −28} |
| | | {−20} {−11} {5} {11} {28 29} {46} {48} {64 65} {82 83} {100 101} |
| | | {111} |
| 5 | 7 × 2 + 12 × 1 | {−117} {−103} {−97} {−85 −84} {−67} {−62} {−50 −49} {−31 −30} |
| | | {−13 −12} {12 13} {30 31} {47} {49} {62} {67} {84 85} |
| | | {103} {108} {117} |
| 6 | 10 × 2 + 6 × 1 | {−118} {−105 −104} {−87 −86} {−69 −68} {−51} {−48} {−33 −32} |
| | | {−15 −14} {14 15} {32 33} {50 51} {68} {76} {86 87} {104 105} |
| | | {118} |
| 7 | 10 × 2 + 6 × 1 | {−119} {−107 −106} {−89 −88} {−71 −70} {−53 −52} {−36} {−34} |
| | | {−17 −16} {16 17} {34 35} {52 53} {70 71} {88} {90} {106 107} |
| | | {119} |
| 8 | 7 × 2 + 12 × 1 | {−120} {−109 −108} {−98 −91} {−73 −72} {−55 −54} {−37} {−35} |
| | | {−22} {−18} {18 19} {37} {44} {54 55} {72 73} {89} {91} |
| | | {102} {109} {120} |
| 9 | 9 × 2 + 8 × 1 | {−121} {−111 −110} {−93 −92} {−75 −74} {−57 −56} {−39 −38} |
| | | {−21} {−10} {20 21} {38 39} {56} {57} {74 75} {92 93} |
| | | {110} {116} {121} |

In some cases, there may be a need for modified or specific preamble design to accommodate the integration of small TD-RUs into a combined TD-RU.

In some cases, there may be one or more preamble designs based on one or more techniques described herein that are applicable to one or more examples/embodiments described herein. In one case, the legacy fields of the preamble such as L-STF (short training field), L-LTF (long training field), L-SIG, RL-SIG may follow the same design of the legacy preamble such that the legacy STAs can decode the legacy part of the preamble.

In one case, the STF of the PPDU containing TD-RUs may follow the same tone plan of the TD-RUs such that the STA transmitting the PPDU may use the same STF sequence used for regular RUs with the STF coefficients mapped to the new tones in the tone plan of the TD-RU.

The STA transmitting the PPDU may set to zero the coefficients that are corresponding to subcarriers that are not modulated in the Data field of the PPDU containing TD-RUs. Those subcarriers that are not modulated in the Data field are referring to the subcarriers of another TD-RU which may be allocated to a different STA.

In one case, the LTF of the PPDU containing TD-RUs may follow the same tone plan of the TD-RUs such that the STA transmitting the PPDU may use the same LTF sequence used for regular RUs with the LTF coefficients mapped to the new tones in the tone plan of the TD-RU.

The STA transmitting the PPDU may set to zero the coefficients that are corresponding to subcarriers which are not modulated in the Data field of the PPDU containing TD-RUs. Those subcarriers that are not modulated in the Data field are referring to the subcarriers of another TD-RU which may be allocated to a different STA.

In one case, a PPDU may be used to carry regular RUs only, TD-RUs only, or it may be used to carry both regular RUs and TD-RUs in the same PPDU but using different subchannels. In one example, a PPDU of bandwidth 80 MHz (contains 4 subchannels each of 20 MHz bandwidth) may be used to carry TD-RUs in the primary 20 MHz subchannel or any other 20 MHz subchannel in the 80 MHz bandwidth of the PPDU while the 3 remaining 20 MHz subchannels may be used to carry regular RUs. In another example, 40 MHz subchannel of the 80 MHz channel may be used for regular RUs and the other 40 MHz subchannel may be used for the TD-RUs.

In one case, the U-SIG field may contain a PPDU Type field to indicate the type of the PPDU which may be set to a value (such as 0) to signal that the PPDU contains regular RUs, set to a value (such as 1) to signal that the PPDU contains TD-RUs, or set to a value (such as 2) to signal that the PPDU contains both regular RUs and TD-RUs. The receiver STA of the PPDU may then follow the preamble, tone-plan, and pilot design of indicated type of RUs carried by this PPDU.

In one case, the U-SIG field may contain a Bandwidth field to indicate the bandwidth of the PPDU. The Bandwidth field may indicate the bandwidth over which the tones of the TD-RUs in the PPDU are distributed. In another embodiment, the Bandwidth field may indicate the entire bandwidth of the PPDU and another field in the U-SIG (may be called TD-RU Bandwidth) may be used to indicate the bandwidth over which the tones of the TD-RUs in the PPDU are distributed. In one example, the Bandwidth field may indicate a PPDU bandwidth of 80 MHz and the TD-RU Bandwidth field may indicate a bandwidth of 20 MHz which signals to the receiver of the PPDU that the TD-RUs are distributed over 20 MHz bandwidth.

In some cases, there may be signaling for resource allocation.

In one case, the transmitter of a PPDU containing TD-RUs may indicate in the SIG field a TD-RU identifier that uniquely identifies the range and locations of the subcarriers comprising the TD-RU. Accordingly, the receiver of the PPDU containing the TD-RUs may use the RU identifier to receive the PPDU correctly.

In one case, the AP may send a trigger frame to allocate one or more TD-RU in a trigger based (TB)-PPDU for one or more STAs and the STA may transmit the TB-PPDU such that the preamble and the data is mapped to the corresponding tones of the TD-RUs as indicated in the trigger frame.

In one case, the U-SIG, UHR-SIG, or any other SIG field may be used to indicate for each subchannel of a PPDU whether regular RUs are used in this subchannel or TD-RUs are used. In one example, each 20 MHz may have an indication of whether this 20 MHz is used for regular RUs or TD-RUs. A field named RU Type may be set to a value (such as 0) to indicate that a given 20 MHz is comprised of regular RUs and may be set to another value (such as 1) to indicate that a given 20 MHz is comprised of TD-RUs. In another example, a bit map may be used for each 80 MHz of a PPDU to indicate for each 20 MHz subchannel if the corresponding subchannel is comprised of regular RUs or TD-RUs. In one example, the RU Type may be set to a bitmap 1000 to indicate that the first 20 MHz subchannel of an 80 MHz subblock is used for TD-RUs while the second, third, and forth 20 MHz subchannels are used for regular RUs.

In one case, the indication of the TD-RU allocation may reuse the RU Allocation indices of the regular RUs considering the tone plan in which larger RUs can be comprised of smaller RUs.

In one case, the RU Allocation indices may be different for TD-RUs for the tone plan design in which a single subchannel may contain either regular RUs or TD-RUs. The RU Allocation Index may indicate the combination of TD-RUs in addition to the tone group size used in the corresponding allocation as listed in Table 12.

TABLE 12
Example RU Allocation Indices for TD-RUs
Considering Different Tone Group Sizes

| | | | | | | | | | | T | |
|---|---|---|---|---|---|---|---|---|---|---|---|
| | | | | | | | | | | Number | |
| | | | | | | | | | | of Tones | |
| RU | | | | | | | | | | in each | Number |
| Alloca- | | | | | | | | | | Tone | of |
| tion | 1 | 2 | 3 | 4 | 5 | 6 | 7 | 8 | 9 | Group | Entries |
| 0 | 26 | 26 | 26 | 26 | 26 | 26 | 26 | 26 | 26 | 1 | 1 |
| 1 | 26 | 26 | 26 | 26 | 26 | 26 | 26 | 26 | 26 | 2 | 1 |
| 2 | 26 | 26 | 26 | 26 | 26 | 26 | 26 | 26 | 26 | 3 | 1 |
| 3 | 26 | 26 | 26 | 26 | 26 | 26 | 26 | 26 | 26 | 4 | 1 |
| 4 | 26 | 26 | 26 | 26 | 26 | 26 | 26 | 26 | 26 | 6 | 1 |
| 5 | 26 | 26 | 26 | 26 | 26 | 26 | 26 | 26 | 26 | 8 | 1 |

| | | | | | | | | | | |
|---|---|---|---|---|---|---|---|---|---|---|
| 6 | 52 | 26 | 26 | 26 | 26 | 26 | 26 | 26 | 1 | 1 |
| 7 | 52 | 26 | 26 | 26 | 26 | 26 | 26 | 26 | 2 | 1 |
| 8 | 52 | 26 | 26 | 26 | 26 | 26 | 26 | 26 | 3 | 1 |
| 9 | 52 | 26 | 26 | 26 | 26 | 26 | 26 | 26 | 4 | 1 |
| 10 | 52 | 26 | 26 | 26 | 26 | 26 | 26 | 26 | 6 | 1 |
| 11 | 52 | 26 | 26 | 26 | 26 | 26 | 26 | 26 | 8 | 1 |

| | | | | | | | | | |
|---|---|---|---|---|---|---|---|---|---|
| 12 | 52 | 52 | 26 | 26 | 26 | 26 | 26 | 1 | 1 |
| 13 | 52 | 52 | 26 | 26 | 26 | 26 | 26 | 2 | 1 |
| 14 | 52 | 52 | 26 | 26 | 26 | 26 | 26 | 3 | 1 |
| 15 | 52 | 52 | 26 | 26 | 26 | 26 | 26 | 4 | 1 |
| 16 | 52 | 52 | 26 | 26 | 26 | 26 | 26 | 6 | 1 |
| 17 | 52 | 52 | 26 | 26 | 26 | 26 | 26 | 8 | 1 |

| | | | | | | | | |
|---|---|---|---|---|---|---|---|---|
| 18 | 52 | 52 | 52 | 26 | 26 | 26 | 1 | 1 |
| 19 | 52 | 52 | 52 | 26 | 26 | 26 | 2 | 1 |
| 20 | 52 | 52 | 52 | 26 | 26 | 26 | 3 | 1 |
| 21 | 52 | 52 | 52 | 26 | 26 | 26 | 4 | 1 |
| 22 | 52 | 52 | 52 | 26 | 26 | 26 | 6 | 1 |
| 23 | 52 | 52 | 52 | 26 | 26 | 26 | 8 | 1 |

| | | | | | | | |
|---|---|---|---|---|---|---|---|
| 24 | 52 | 52 | 52 | 52 | 26 | 1 | 1 |
| 25 | 52 | 52 | 52 | 52 | 26 | 2 | 1 |
| 26 | 52 | 52 | 52 | 52 | 26 | 3 | 1 |
| 27 | 52 | 52 | 52 | 52 | 26 | 4 | 1 |
| 28 | 52 | 52 | 52 | 52 | 26 | 6 | 1 |
| 29 | 52 | 52 | 52 | 52 | 26 | 8 | 1 |

| | | | | | | |
|---|---|---|---|---|---|---|
| 30 | 106 | 52 | 52 | 26 | 1 | 1 |
| 31 | 106 | 52 | 52 | 26 | 2 | 1 |
| 32 | 106 | 52 | 52 | 26 | 3 | 1 |
| 33 | 106 | 52 | 52 | 26 | 4 | 1 |
| 34 | 106 | 52 | 52 | 26 | 6 | 1 |
| 35 | 106 | 52 | 52 | 26 | 8 | 1 |

| | | | | | |
|---|---|---|---|---|---|
| 36 | 106 | 106 | 26 | 1 | 1 |
| 37 | 106 | 106 | 26 | 2 | 1 |
| 38 | 106 | 106 | 26 | 3 | 1 |
| 39 | 106 | 106 | 26 | 4 | 1 |
| 40 | 106 | 106 | 26 | 6 | 1 |
| 41 | 106 | 106 | 26 | 8 | 1 |

In one case, the transmitter of the PPDUs containing TD-RUs may indicate the resource allocation of the used TD-RUs in the SIG fields in case of single user (SU) or multi-user (MU) PPDUs and map the STF, LTF, pilot, and Data subcarriers to the tones of the corresponding TD-RU tones as specified by the tone plan. In one case, the transmitter of the PPDUs containing TD-RUs may use the resource allocation of the used TD-RUs as indicated in the trigger frame in case of Trigger Based (TB) PPDUs and map the STF, LTF, pilot and Data subcarriers to the tones of the corresponding TD-RU tones as specified by the tone plan.

In one case, the receiver of the PPDUs containing TD-RUs may use the indication of the resource allocation of the used TD-RUs in the SIG fields in case of single user (SU) or multi-user (MU) PPDUs and use the corresponding STF, LTF, pilot, and Data subcarriers of the tones of the corresponding TD-RU tones as specified by the tone plan.

In one case, the receiver of the TB-PPDUs containing TD-RUs may use the resource allocation of the used TD-RUs as indicated in the trigger frame sent by itself in case of Trigger Based (TB) PPDUs and use the STF, LTF, pilot and Data subcarriers of the tones of the corresponding TD-RU tones as specified by the tone plan.

In regular RUs, pilot subcarriers may be used to make the coherent detection robust against frequency offsets and/or phase noise. Pilot subcarriers may be located within the subcarrier range of each RU with all the subcarriers of a given RU are contiguous. In TD-RUs, the subcarriers of the RU may be distributed over a much wider bandwidth that may render the pilot subcarriers of the regular RUs not useful. Accordingly, practical design of the pilot subcarriers of the TD-RUs is discussed further herein.

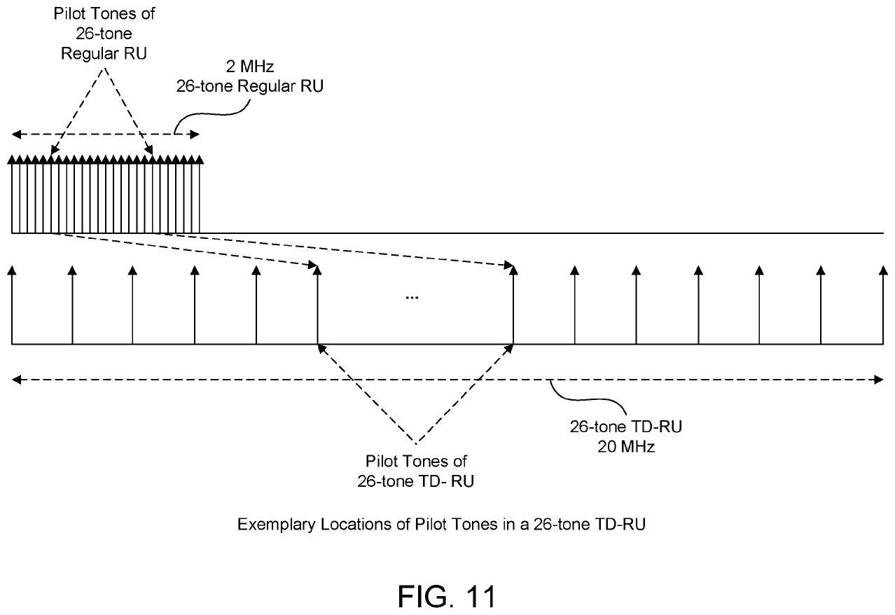

FIG. 11 illustrates an example of locations of pilot tones in a 26-tone TD-RU.

In one case, the pilot tones of a regular RU are mapped to the corresponding tones in the TD-RU. In one example, a 26-tone regular RU may contain 2 pilot tones which may be mapped to the corresponding 2 tones over the TD-RU bandwidth (such as 20 MHz) as illustrated in FIG. 11. Similarly, the pilot tones of 52-tone, 106-tone, 242-tone, 484-tone, or 996-tone RU may be mapped to the corresponding tones in a TD-RU in a wider TD-RU bandwidth (such as 40 MHz, 80 MHz, 160 MHz, or 320 MHz).

In one case, to maintain the robustness of the phase tracking accuracy at the receiver, the number of pilot tones per one TD-RU may be increased as compared to the regular RU due to the distributed nature of the TD-RU.

In one case, the pilot tones of 242-tone RU (8 pilot tones in 802.1 lax and 802.11be) may be used by the small TD-RUs such as (26-tone, 52-tone, 106-tone TD-RUs) in addition to the pilot tones of each TD-RU. In one example, a 26-tone TD-RU may use the 2 pilot tones of the corresponding 26-tone regular RU in addition to one or more tones of the 242-tone regular RU located in the same 20 MHz.

In one case, the pilot tones of 484-tone RU (16 pilot tones in 802.11ax and 802.11be specs) may be used by the small TD-RUs such as (26-tone, 52-tone, 106-tone TD-RUs) in addition to the pilot tones of each TD-RU. In one example, a 26-tone TD-RU may use the 2 pilot tones of the corresponding 26-tone regular RU in addition to one or more tones of the 484-tone regular RU located in the same 40 MHz.

In one case, the pilot tones of 996-tone RU (32 pilot tones in 802.1 lax and 802.11be specs) may be used by the small TD-RUs such as (26-tone, 52-tone, 106-tone TD-RUs) in addition to the pilot tones of each TD-RU. In one example, a 26-tone TD-RU may use the 2 pilot tones of the corresponding 26-tone regular RU in addition to one or more tones of the 996-tone regular RU located in the same 80 MHz.

In one case, the conventional pilot tones (as defined in 802.11ax and/or 802.11be) of regular RUs may be reused for the for the TD-RUs such that each TD-RU is assigned pilot tones with the distance between the pilot tones (e.g., measured in number of subcarriers) is maximized or sufficiently large. In one example, a 26-tone TD-RU may be assigned two of the 18 conventional pilot tones of the nine 26-tone regular RUs in 20 MHz channel with the distance (e.g., measured in number of subcarriers) between the pilot tones maximized or sufficiently large for the nine TD-RUs. One example of the pilot tone allocation is listed in Table 13.

TABLE 13
Example Allocation of Pilot Tones with Maximized
Distance between the Pilot Tones

| TD-RU Index | Pilot Tones |
|---|---|
| 1 | {−116, 10} |
| 2 | {−102, 22} |
| 3 | {−90, 36} |
| 4 | {−76, 48} |
| 5 | {−62, 62} |
| 6 | {−48, 76} |
| 7 | {−36, 90} |
| 8 | {−22, 102} |
| 9 | {−10, 116} |

In one case, the pilot tones of a TD-RU may be allocated such that the pilot tones are in the tone plan closer to the groups of data tones in case the tones of the TD-RU are grouped.

In one case, a 26-tone TD-RU may be allocated more than two pilot tones. In one example, a 26-tone TD-RU may be allocated an extra pilot tone in addition to the two conventional pilot tones. The nine 26-tone TD-RUs in a 20 MHz channel may use the 4 null subcarriers {−122, −69, 69, 122}, 4 of the DC subcarriers, namely {−4, −3, 3, 4}, and one of the left guard subcarriers as the extra pilot tones. The 26-tone TD-RU may be then renamed (26+1)-tone TD-RU.

In one case, a 52-tone TD-RU may be allocated more than four pilot tones. In one example, a 52-tone TD-RU may be allocated two extra pilot tone in addition to the four conventional pilot tones. The four 52-tone TD-RUs in a 20 MHz channel may use the 4 null subcarriers {−122, −69, 69, 122} and 4 of the DC subcarriers, namely {−4, −3, 3, 4} as the extra pilot tones. The 52-tone TD-RU may be then renamed (52+2)-tone TD-RU.

In one case, a 106-tone TD-RU may be allocated more than four pilot tones. In one example, a 106-tone TD-RU may be allocated two or more extra pilot tone in addition to the four conventional pilot tones. The two 106-tone TD-RUs in a 20 MHz channel may use the 4 null subcarriers {−122, −69, 69, 122} and/or 4 of the DC subcarriers, namely {−4, −3, 3, 4} as the extra pilot tones. The 106-tone TD-RU may be then renamed (106+2)-tone TD-RU or (106+3)-tone TD-RU.

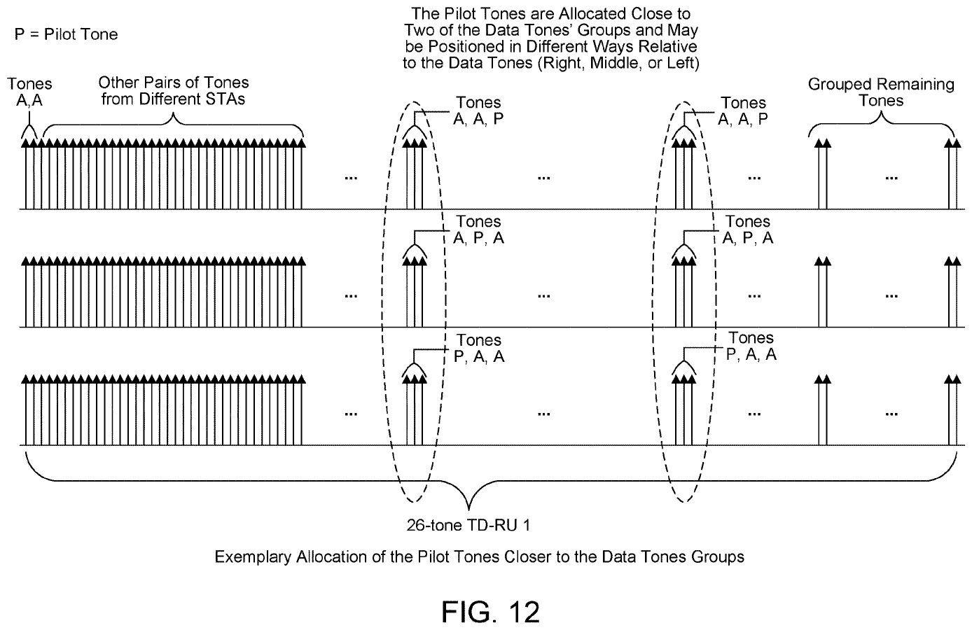

In one embodiment, the pilot tones may be allocated to be closer to some of the data tones' groups in cases where the number of data tones' groups are larger than the number of pilot tones. In one example, a 26-tone TD-RU has two pilot tones and 24 data tones which may be grouped into 12 groups each of 2 data tones. In this example, the two pilot tones may be allocated to be closer to two of the 12 data tones groups and may be chosen to be located to the right of the data tones group, or to be located to the left of the data tones group, or to be located in the middle of the data tones group as illustrated in FIG. 12. In FIG. 12, example STA tones is labeled “A” and a pilot tone is labeled “P”. The arrangement patterns are shown with the pilot tone in different positions with respect the “A” tones.

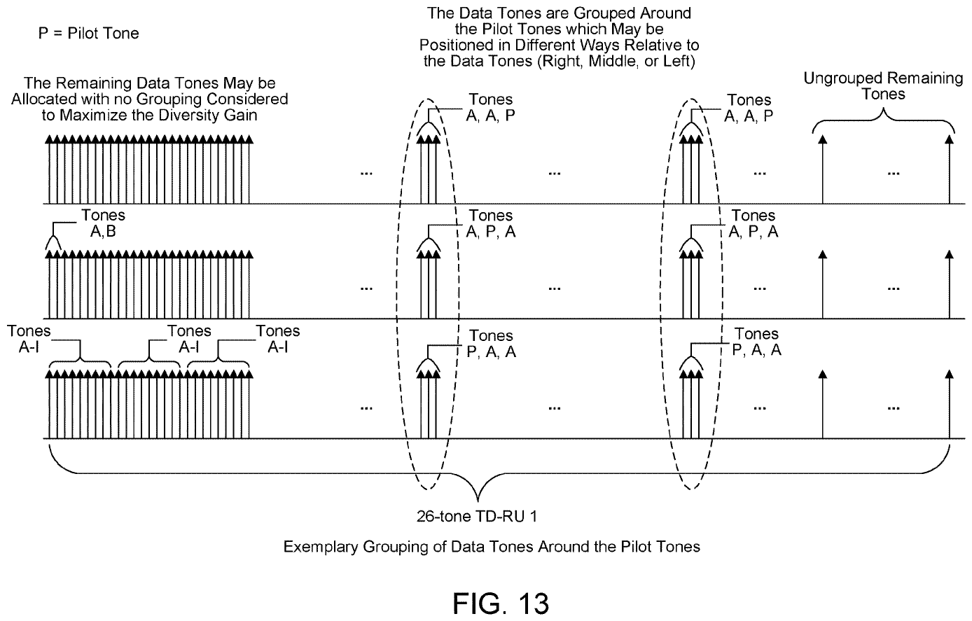

In one embodiment, some data tones (one or more) may be grouped around the pilot tones to improve the phase tracking performance while the remaining data tones are left ungrouped. In one example, as depicted in FIG. 13, the tones of a 26-tone TD-RU may be planned such that each pilot tone is grouped with two (or more) data tones as in FIG. 12. The pilot tone may be chosen to be located to the right of the data tones group, or to be located to the left of the data tones group, or to be in the middle of the data tones group. The remaining data tones may then be allocated evenly across the channel bandwidth and left ungrouped to improve the gains of frequency diversity.

In one embodiment, the grouping of the data tones may be around all pilot tones or some of the pilot tones. In one example, a 26-tone TD-RU may have two pilot tones in which one of the pilot tones is allocated closer to a group of data tones while the other pilot tone and the remaining data tones are left ungrouped.

In OFDM modulation, the repeated sequences of pilot tones in small regular RUs or Tone-Distributed RUs (TD-RUs) may increase the Peak-to-Average Power Ratio (PAPR) when the BSS bandwidth is allocated to many STAs leading to a worse performance. Application of different phase rotations to different RUs may improve the performance by reducing the PAPR. Signaling of the per RU phase rotation is an open problem addressed hereinbelow.

In one embodiment, a set of phase rotation sequences may be designed for the pilot tones such that each regular RU/MiRU or TD-RUs are allocated a different phase rotation sequence which is a function of the RU/MRU or TD-RU index such that the designated receiver can identify the phase rotation sequence or the index of the sequence from assigned regular RU/MRU or TD-RU index.

In one embodiment, the per RU (rRU. rMRU or TD-RU) phase rotation sequences may be chosen from predesigned sequences as listed in Table 14. In one method, the phase rotation per RU may be applied based on the list below for each 20 MHz channel such that the phase rotation of Index 1 is applied to the first (rRU. rMRU or TD-RU) and the phase rotation of Index 2 is applied to the second (rRU. rMRU or TD-RU) and so on. In one example, nine 26-tone rRUs or TD-RUs may be allocated where each phase rotation in the list below is applied to one of the nine rRUs or TD-RUs. In another example, four 52-tone and one 26-tone rRUs or TD-RUs may be allocated where the first 5 phase rotations are applied to the five rRUs or TD-RUs in the order of the frequency from smaller to larger frequency.

In another method, the phase rotation applied to each (rRU. rMRU or TD-RU) may be signaled in the User field in the content channel of the SIG field corresponding to the RU Allocation field, In one example, one bit (named Phase Rotation) may be used and set to a value (such as 0) to indicate that a phase rotation of −1 is applied and may be set to another value (such as 1) to indicate that a phased rotation of 1 is applied.

TABLE 14
Example per-RU (rRU. rMRU or TD-RU) Phase Rotation

| Index | Phase Rotation |
|---|---|
| 1 | 1 |
| 2 | −1 |
| 3 | 1 |
| 4 | −1 |
| 5 | 1 |
| 6 | −1 |
| 7 | 1 |
| 8 | −1 |
| 9 | 1 |

In one embodiment, the receiver of the PPDU may decode the SIG field to identify the resource allocation corresponding to its user field and determine the phase rotation applied to the pilot tones of the corresponding resource (e.g., rRU. rMRU or TD-RU).

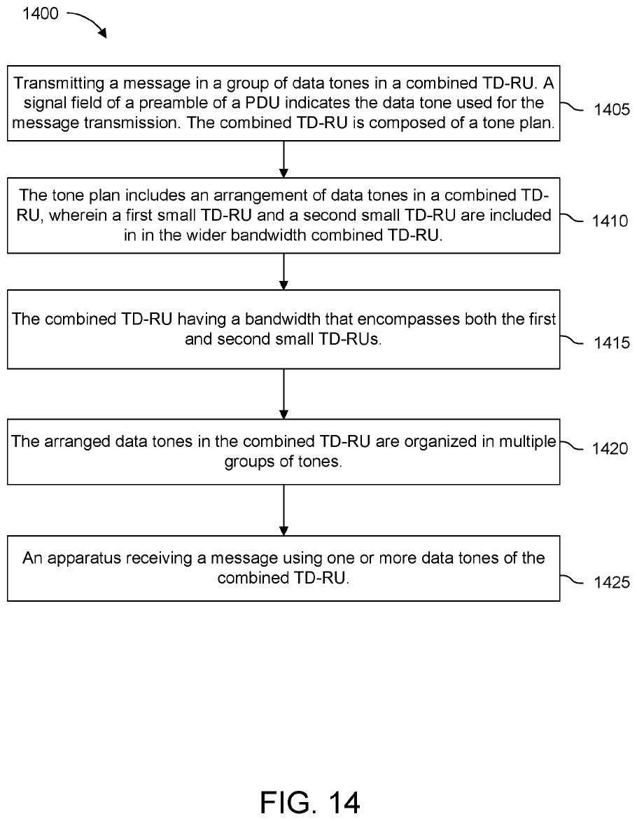

FIG. 14 depicts an example method 1400 based on the disclosure. At 1405, an apparatus, such as a WTRU, transmits a message, using a one or more tones (subcarriers), in a group of data tones in a combined TD-RU. In the transmission, a signal field of a preamble of a protocol data unit (PDU) indicates a specific data tone is used for the transmission of the message. The TD-RU is composed of a tone plan.

At 1410, a description of the tone plan includes an arrangement of data tones in a combined TD-RU, wherein a first small TD-RU and a second small TD-RU are included in the wider bandwidth combined TD-RU.

At 1415, the tone plan may further include the feature of a combined TD-RU having a bandwidth that encompasses both the first and second small TD-RUs.

At 1420, the tone plan may further include the feature that the arranged data tones in the combined TD-RU are organized in multiple groups of tones.

At 1425, The method includes the step of an apparatus receiving a message via one or more data tones of the combined TD-RU.

Other features of an arrangement of tones in a tone plan may include a condition where each group of tones includes at least one data tone from the first small TD-RU and one data tone from the second small TD-RU, wherein the multiple groups are distributed over the bandwidth of the combined TD-RU.

Another feature may include the addition of pilot tones from each of the first small TD-RU and the second small TD-RU to be distributed along with the multiple groups of tones. Here, the pilot tones may be arranged to be located either before a group of data tones, inside a group of data tones, or after a group of data tones. In another possible feature, the pilot tones of the first small TD-RU and the second small TD-RU may be distributed into the combined TD-RU such that the distributed pilot tones occur farther apart in frequency from each other in the combined TD-RU. Also, the arrangement of data tones in the combined TD-RU may further include a number of additional pilot tones for the combined TD-RU, each of the additional pilot tones arranged to be associated with a respective group of tones in the combined TD-RU. In another feature, data tones not associated with pilot tones are not grouped together in the combined TD-RU.

In one example, the combined TD-RU includes at least 26 tones distributed over at least 20 MHz (or 40 MHZ) of the combined TD-RU. An indication of the multiple groups of tones in the combined TD-RU may be transmitted in the signal field of the preamble of the PDU.

In another example, the combined TD-RU is a 20 MHZ resource for use by both a first WTRU and a second WTRU.

In one feature, the preamble of the PDU may include a phase rotation indication applied to a combined TD-RU in a user field of a content channel in the signal field. The preamble may further include a field indicating single user or multi-user.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method performed by a station (STA), the method comprising:
receiving, from an access point (AP), a trigger frame, and
transmitting to the AP, in response to the trigger frame, a physical protocol data unit (PPDU) according to a tone plan,
wherein the tone plan comprises subcarrier tones of a first tone distributed resource unit (TDRU) corresponding to a first distributed resource unit (DRU) index and subcarrier tones of a second TDRU corresponding to a second DRU index distributed over a distribution bandwidth, wherein the distribution bandwidth includes a combined bandwidth of the first TDRU and the second TDRU, and
wherein the subcarrier tones corresponding to both the first and the second DRU indices are organized in multiple groups of tones, each group of tones comprising at least one data tone from the first TDRU and one data tone from the second TDRU.

2-14. (canceled)

15. A station (STA) comprising, circuitry including a transmitter, a receiver, a processor, and a memory, configured to:
receive, from an access point (AP), a trigger frame, and
transmit to the AP, in response to the trigger frame, a physical protocol data unit (PPDU) according to a tone plan,
wherein the tone plan comprises subcarrier tones of a first tone distributed resource unit (TDRU) corresponding to a first distributed resource unit (DRU) index and subcarrier tones of a second TDRU corresponding to a second DRU index distributed over a distribution bandwidth, wherein the distribution bandwidth includes a combined bandwidth of the first TDRU and the second TDRU, and
wherein the subcarrier tones corresponding to both the first and the second DRU indices are organized in multiple groups of tones, each group of tones comprising at least one data tone from the first TDRU and one data tone from the second TDRU.

16-27. (canceled)

28. The method of claim 1, wherein the PPDU comprises one or more regular resource units (RRUs).

29. The method of claim 28, wherein the PPDU includes a channel comprising one or more first subchannels carrying the one or more RRUs and one or more second subchannels carrying the first TDRU or the second TDRU.

30. The method of claim 1, wherein the trigger frame comprises a type field to indicate which type of resource units (RUs) the PPDU is carrying.

31. The method of claim 30, wherein the type field comprises information indicating that the PPDU includes:
only TDRUs; or
at least one RRU and one TDRU.

32. The method of claim 1, wherein pilot tones from each of the first TDRU and the second TDRU are distributed along with the multiple groups of tones.

33. The method of claim 1, wherein the first TDRU comprises a 26-tone DRU or a 52-tone DRU and the second TDRU comprises a 26-tone DRU or a 52-tone DRU.

34. The method of claim 1, wherein the distribution bandwidth is one of 20 MHz, 40 MHz, 80 MHz, or 160 MHz.

35. The STA of claim 15, wherein the PPDU comprises one or more regular resource units (RRUs).

36. The STA of claim 35, wherein the PPDU includes a channel comprising one or more first subchannels carrying the one or more RRUs and one or more second subchannels carrying the first TDRU or the second TDRU.

37. The STA of claim 15, wherein the trigger frame comprises a type field to indicate which type of RUs the PPDU is carrying.

38. The STA of claim 37, wherein the type field comprises information indicating that the PPDU includes:
only TDRUs; or
at least one RRU and one TDRU.

39. The STA of claim 15, wherein pilot tones from each of the first TDRU and the second TDRU are distributed along with the multiple groups of tones.

40. The STA of claim 15, wherein the first TDRU comprises a 26-tone DRU or a 52-tone DRU and the second TDRU comprises a 26-tone DRU or a 52-tone DRU.

41. The STA of claim 15, wherein the distribution bandwidth is one of 20 MHz, 40 MHz, 80 MHz, or 160 MHz.

42. A method performed by an access point (AP), the method comprising:
transmitting, to a station (STA), a trigger frame; and
receiving, from the STA, in response to the trigger frame, a physical protocol data unit (PPDU) according to a tone plane,
wherein the tone plan comprises subcarrier tones of a first tone distributed resource unit (TDRU) corresponding to a first distributed resource unit (DRU) index and subcarrier tones of a second TDRU corresponding to a second DRU index distributed over a distribution bandwidth, wherein the distribution bandwidth includes a combined bandwidth of the first TDRU and the second TDRU, and
wherein the subcarrier tones corresponding to both the first and the second DRU indices are organized in multiple groups of tones, each group of tones comprising at least one data tone from the first TDRU and one data tone from the second TDRU.

43. The method of claim 42, wherein the PPDU comprises one or more regular resource units (RRUs).

44. The method of claim 42, wherein the PPDU includes a channel comprising one or more first subchannels carrying the one or more RRUs and one or more second subchannels carrying the first TDRU or the second TDRU.

45. The method of claim 42, wherein the trigger frame comprises a type field to indicate which type of resource units (RUs) the PPDU is carrying.
